(19) United States
(12) Patent Application Publication
(10) Pub. No.: US 2025/0275557 A1
(43) Pub. Date: Sep. 4, 2025

(54) WATER-SOLUBLE POUCH

(71) Applicant: Concept Matrix Solutions, Newbury Park, CA (US)

(72) Inventors: Jose Bernardo, Oxnard, CA (US); David Reid, Woodland Hills, CA (US); Tony LaRosa, Woodland Hills, CA (US); Robert Davidson, Woodland Hills, CA (US)

(21) Appl. No.: 19/048,230

(22) Filed: Feb. 7, 2025

Related U.S. Application Data
(60) Provisional application No. 63/551,038, filed on Feb. 7, 2024.

(51) Int. Cl. A23K 40/30

(52) U.S. Cl. CPC A23K 40/30

(57) ABSTRACT

The present invention provides a water-soluble pouch, methods of manufacturing the same, as well as methods of orally administering the same.

### BACKGROUND OF THE INVENTION

Water-soluble pouches (WSPs) are innovative packaging solutions designed to dissolve when exposed to water, offering a convenient and eco-friendly alternative to traditional packaging. These pouches, typically made from materials such as polyvinyl alcohol (PVA), have gained popularity in various industries, particularly in household cleaning and personal care products. According to SmartSolve Industries, water-soluble pouches are comprised of bio-based wood pulp fibers and carboxymethyl cellulose, a safe, food-grade powder commonly used in chewing gum. These pouches have been successfully employed in applications such as laundry detergents, dishwasher tablets, and other cleaning products, where they provide precise dosing and reduce plastic waste.

The use of water-soluble pouches has expanded beyond cleaning products to include applications in agriculture, pharmaceuticals, and more recently, the food industry. In the food sector, water-soluble pouches offer potential benefits such as portion control, reduced packaging waste, and improved convenience for consumers. A study published in Food Production Daily reports that edible film pouches can be engineered to dissolve and release their contents when exposed to water, leaving no notable taste or odor when consumed. This technology has been proposed for use in products such as oatmeal, cereals, instant teas and coffees, soups, and pre-portioned spice packs.

However, several obstacles remain in commercializing water-soluble pouches for food products. One significant challenge, as noted by FKuR, a manufacturer of water-soluble plastics, is the need to balance the pouch's solubility with its structural integrity. Pouches must be sturdy enough to withstand handling and storage while still dissolving effectively when used. Additionally, a comprehensive review published in PubMed highlights concerns regarding the compatibility of water-soluble materials with various food products, especially those containing moisture or fats that could prematurely degrade the pouch.

Another hurdle in commercialization is the cost factor. A market analysis by Global Market Insights points out that the production of water-soluble pouches for food applications often involves higher expenses compared to traditional packaging materials. This cost differential can be a significant barrier to widespread adoption, particularly in price-sensitive food categories. Furthermore, there are regulatory considerations to address, as any material in contact with food must meet stringent safety standards set by authorities such as the U.S. Food and Drug Administration.

Consumer perception and acceptance also play a crucial role in the commercialization of water-soluble pouches for food products. While there is growing interest in sustainable packaging solutions, concerns about the safety, taste, and texture of water-soluble materials when consumed with food products need to be addressed. As the industry continues to innovate and refine water-soluble packaging technologies, overcoming these challenges will be key to realizing the full potential of this packaging solution in the food sector.

### SUMMARY OF THE INVENTION

The present invention provides for a water-soluble pouch (WSP) that includes: solvent, binder, thickener, filler, plasticizer, and sequestering agent.

In specific embodiments, the WSP includes: solvent, binder, thickener, filler, plasticizer, sequestering agent, and emulsifier.

In specific embodiments, the WSP includes: solvent, binder, solubilizer/emulsifier, and plasticizer.

In specific embodiments, the WSP includes: water, pullulan, maltodextrin, microcrystalline cellulose, Na alginate, sorbitol, sodium citrate, and glycerin.

In specific embodiments, the WSP includes: water, pullulan, maltodextrin, endurance microcrystalline cellulose, Na alginate, sorbitol, sodium citrate, glycerin, and sunflower lecithin.

In specific embodiments, the WSP includes: water, polyvinyl alcohol, sodium carboxymethyl cellulose, propylene glycol, polysorbate 80, xylitol, sorbitol, and glycerin.

In specific embodiments, the WSP includes:

| | | Non-volatile | |
|---|---|---|---|
| | | (wt. %) | |
| | Ingredient | (dehydrated | WSP |
| Ingredient | Function | film) | (wt. %) |
| Water, Purified USP | Solvent | up to 0.1 | 5.00 ± 1 |
| Pullulan | Binder | 4.14 ± 1 | 3.93 ± 1 |
| Maltodextrin | Thickener | 38.84 ± 5 | 36.90 ± 7 |
| Endurance Microcrystalline | Filler | 15.13 ± 3 | 14.37 ± 3 |
| Cellulose, FCC | | | |
| Na alginate | Binder | 1.57 ± 0.3 | 1.49 ± 0.3 |
| Sorbitol | Plasticizer | 5.21 ± 1 | 4.95 ± 1 |
| Sodium Citrate | Sequestering | 9.83 ± 1 | 9.34 ± 2 |
| | agent | | |
| Glycerin 99.7% USP | Plasticizer | 25.28 ± 5 | 24.02 ± 5 |
| | Total: | 100.00 | 100 |

In other specific embodiments, the WSP includes:

| | Ingredient | Non-volatile (wt. %) | WSP |
|---|---|---|---|
| Ingredient | Function | (dehydrated film) | (wt. %) |
| Water, Purified USP | Solvent | 0.00 | 5.00 |
| Pullulan | Binder | 4.14 | 3.93 |
| Maltodextrin | Thickener | 38.84 | 36.90 |
| Endurance Microcrystalline | Filler | 15.13 | 14.37 |
| Cellulose, FCC | | | |
| Na alginate | Binder | 1.57 | 1.49 |
| Sorbitol | Plasticizer | 5.21 | 4.95 |
| Sodium Citrate | Sequestering | 9.83 | 9.34 |
| | agent | | |
| Glycerin 99.7% USP | Plasticizer | 25.28 | 24.02 |
| | Total: | 100.00 | 100 |

In other specific embodiments, the WSP includes:

| | Ingredient | WSP | Non-volatile wt. % |
|---|---|---|---|
| Ingredient | Function | wt. % | (dehydrated film) |
| Water, Purified USP | Solvent | 5.00 ± 2 | up to 0.1 |
| Pullulan | Binder | 9.26 ± 2 | 9.75 ± 2 |
| Maltodextrin | Thickener | 24.15 ± 5 | 25.42 ± 5 |
| Endurance | Filler | 9.55 ± 2 | 10.05 ± 2 |
| Microcrystalline | | | |
| Cellulose, FCC | | | |
| Na alginate | Binder | 2.57 ± 0.6 | 2.70 ± 0.6 |
| Sorbitol | Plasticizer | 5.24 ± 1 | 5.52 ± 1.1 |
| Sodium Citrate | Sequestering | 9.90 ± 2 | 10.42 ± 2 |
| | agent | | |
| Glycerin 99.7% USP | Plasticizer | 28.67 ± 6 | 30.18 ± 6 |
| Sunflower Lecithin | Emulsifier | 5.66 ± 1.1 | 5.96 ± 1.1 |
| | Total: | 100% | 100.00% |

In other specific embodiments, the WSP includes:

| | Ingredient | WSP | Non-volatile wt. % |
|---|---|---|---|
| Ingredient | Function | wt. % | (dehydrated film) |
| Water, Purified USP | Solvent | 5.00 | 0.00 |
| Pullulan | Binder | 9.26 | 9.75 |
| Maltodextrin | Thickener | 24.15 | 25.42 |
| Endurance | Filler | 9.55 | 10.05 |
| Microcrystalline | | | |
| Cellulose, FCC | | | |
| Na alginate | Binder | 2.57 | 2.70 |
| Sorbitol | Plasticizer | 5.24 | 5.52 |
| Sodium Citrate | Sequestering | 9.90 | 10.42 |
| | agent | | |
| Glycerin 99.7% USP | Plasticizer | 28.67 | 30.18 |
| Sunflower Lecithin | Emulsifier | 5.66 | 5.96 |
| | Total: | 100% | 100.00% |

In other specific embodiments, the WSP includes:

| | | | Non-volatile |
|---|---|---|---|
| | Ingredient | WSP | wt. % |
| Ingredient | Function | wt. % | (dehydrated film) |
| Water, Purified USP | Solvent | 5.00 ± 1 | up to 0.01 |
| Polyvinyl Alcohol | Binder | 60.17 ± 12 | 63.34 ± 15 |
| Sodium Carboxymethyl | Binder | 7.86 ± 1.5 | 8.28 ± 2 |
| Cellulose | | | |
| Propylene Glycol | Solubilizer/ | 11.87 ± 2.2 | 12.49 ± 2.5 |
| | emulsifier | | |
| Polysorbate 80 | Emulsifier | 0.84 ± 0.2 | 0.89 ± 0.2 |
| Xylitol | Plasticizer | 5.27 ± 1.2 | 5.54 ± 1.1 |
| Sorbitol | Plasticizer | 4.42 ± 1 | 4.66 ± 1 |
| Glycerin 99.7% USP | Plasticizer | 4.56 ± 1 | 4.80 ± 1 |
| | Total: | 100% | 100.00% |

In other specific embodiments, the WSP includes:

| | Ingredient | WSP | Non-volatile wt. % |
|---|---|---|---|
| Ingredient | Function | wt. % | (dehydrated film) |
| Water, Purified USP | Solvent | 5.00 | 0.00 |
| Polyvinyl Alcohol | Binder | 60.17 | 63.34 |
| Sodium Carboxymethyl | Binder | 7.86 | 8.28 |
| Cellulose | | | |
| Propylene Glycol | Solubilizer/ | 11.87 | 12.49 |
| | emulsifier | | |
| Polysorbate 80 | Emulsifier | 0.84 | 0.89 |
| Xylitol | Plasticizer | 5.27 | 5.54 |
| Sorbitol | Plasticizer | 4.42 | 4.66 |
| Glycerin 99.7% USP | Plasticizer | 4.56 | 4.80 |
| | Total: | 100% | 100.00% |

The present invention also provides for a slurry (useful for making a WSP) that includes: solvent, binder, thickener, filler, plasticizer, and sequestering agent. In specific embodiments, the slurry includes:

| Ingredient | Ingredient Function | Amount wt. % (slurry) |
|---|---|---|
| Water, Purified USP | Solvent | 35-55 |
| Pullulan | Binder | 1.5-3 |
| Maltodextrin | Thickener | 18-23 |
| Endurance | Filler | 6-10 |
| Microcrystalline | | |
| Cellulose, FCC | | |
| Na alginate | Binder | 0.5-2 |
| Sorbitol | Plasticizer | 1.5-3.5 |
| Sodium Citrate | Sequestering agent | 3-6.5 |
| Glycerin 99.7% USP | Plasticizer | 12-15 |
| | Total: | 100.00 |

In other specific embodiments, the slurry includes:

| Ingredient | Ingredient Function | Amount wt. % (slurry) |
|---|---|---|
| Water, Purified USP | Solvent | 46.600 |
| Pullulan | Binder | 2.210 |
| Maltodextrin | Thickener | 20.740 |
| Endurance | Filler | 8.080 |
| Microcrystalline | | |
| Cellulose, FCC | | |
| Na alginate | Binder | 0.840 |
| Sorbitol | Plasticizer | 2.78 |
| Sodium Citrate | Sequestering agent | 5.25 |
| Glycerin 99.7% USP | Plasticizer | 13.50 |
| | Total: | 100.00 |

In other specific embodiments, the slurry includes:

| Ingredient | Ingredient Function | Slurry wt. % Range |
|---|---|---|
| Water, Purified USP | Solvent | 35-55 |
| Pullulan | Binder | 3-6 |
| Maltodextrin | Thickener | 10-15 |
| Endurance | Filler | 3.0-8.0 |
| Microcrystalline | | |
| Cellulose, FCC | | |
| Na alginate | Binder | 0.5-2.5 |
| Sorbitol | Plasticizer | 1.5-4.0 |
| Sodium Citrate | Sequestering agent | 3-6.5 |
| Glycerin 99.7% USP | Plasticizer | 12-17 |
| Sunflower Lecithin | Emulsifier | 2.0-4.5 |
| | Total: | 100.000 |

In other specific embodiments, the slurry includes:

| Ingredient | Ingredient Function | Slurry wt. % |
|---|---|---|
| Water, Purified USP | Solvent | 49.640 |
| Pullulan | Binder | 4.910 |
| Maltodextrin | Thickener | 12.800 |
| Endurance | Filler | 5.060 |
| Microcrystalline | | |
| Cellulose, FCC | | |
| Na alginate | Binder | 1.360 |
| Sorbitol | Plasticizer | 2.78 |
| Sodium Citrate | Sequestering agent | 5.25 |
| Glycerin 99.7% USP | Plasticizer | 15.20 |
| Sunflower Lecithin | Emulsifier | 3.00 |
| | Total: | 100.000% |

In other specific embodiments, the slurry includes:

| Ingredient | Ingredient Function | Slurry wt. % Range |
|---|---|---|
| Water, Purified USP | Solvent | 80-90 |
| Polyvinyl Alcohol | Binder | 6-12 |
| Sodium Carboxymethyl | Binder | 0.5-3.0 |
| Cellulose | | |
| Propylene Glycol | Solubilizer/ | 1.0-3.0 |
| | emulsifier | |
| Polysorbate 80 | Emulsifier | 0.1-2.0 |
| Xylitol | Plasticizer | 0.5-2.0 |
| Sorbitol | Plasticizer | 0.5-2.0 |
| Glycerin 99.7% USP | Plasticizer | 0.5-2.0 |
| | Total: | 100.000 |

In other specific embodiments, the slurry includes:

| Ingredient | Ingredient Function | Slurry wt. % |
|---|---|---|
| Water, Purified USP | Solvent | 86.470 |
| Polyvinyl Alcohol | Binder | 8.570 |
| Sodium Carboxymethyl | Binder | 1.120 |
| Cellulose | | |
| Propylene Glycol | Solubilizer/ | 1.690 |
| | emulsifier | |
| Polysorbate 80 | Emulsifier | 0.120 |
| Xylitol | Plasticizer | 0.750 |
| Sorbitol | Plasticizer | 0.63 |
| Glycerin 99.7% USP | Plasticizer | 0.65 |
| | Total: | 100.000% |

The present invention also provides a method of orally administering the water-soluble pouch described herein, to an animal (e.g., human).

The present invention also provides a method of manufacturing a water-soluble pouch, the method as described herein.

### DETAILED DESCRIPTION OF THE INVENTION

It is appreciated that those of skill in the art understand that reference herein to a water-soluble pouch as including indicated substances is also a reference to the water-soluble pouch as being manufactured from such indicated substances. It is also appreciated that those of skill in the art understand that reference to the slurry described herein as including indicated substances is also a reference to the slurry as being manufactured from such indicated substances.

The present invention can be more readily understood by reading the following detailed description of the invention and study of the included examples.

As used herein, the following terms have the meanings ascribed to them unless specified otherwise.

The terms “comprise,” “comprising,” “include,” “including,” and “includes” when used in this specification and claims are intended to specify the presence of stated substances, features, integers, components, or steps, but they do not preclude the presence or addition of one or more other substances, features, integers, components, steps, or combinations thereof.

The term “about” modifies the subject values, such that they are within an acceptable error range, as determined by one of ordinary skill in the art, which will depend in part on the limitations of the measurement system.

The articles “a” and “an” as used herein refers to “one or more” or “at least one,” unless otherwise indicated. That is, reference to any element or component of an embodiment by the indefinite article “a” or “an” does not exclude the possibility that more than one element or component is present.

The term “solvent” refers to a substance that is used in the pharmaceutical preparation of a water-soluble pouch, to dissolve the active pharmaceutical ingredient (API) and/or excipients. A solvent can be employed to form a slurry. For most manufacturing methods, solvents improve solubility of the active ingredient within the film forming matrix. Solvents may be chosen based on the active ingredient's solubility therein. Preferred solvents include volatile class 3 residual solvents such as ethanol and acetone and non-volatile solvents such as water. In some embodiments, the solvent is at least one of ethanol and water. Upon curing of a slurry to provide a water-soluble pouch, a significant portion of the solvent will typically be removed, leaving behind a remaining (or residual) portion of the solvent.

The term “binder” (and equivalent terms such as “binding agent”) refers to a substance, typically a polymer, used in the pharmaceutical preparation of oral solid dosage forms (e.g., water-soluble pouch) to hold the ingredients together. Binders ensure that the water-soluble pouches can be formed with the requisite mechanical strength. The binders also provide the requisite volume to low amount of active present in soluble films. The presence of the binder can also facilitate the formation of the cured film. As such, the binder includes those substances, which when present in the cast slurry and upon curing, will effectively provide for a cured film. In designing of a water-soluble pouch formulation, consideration should be given to the target product and drug release profile. A primary component of a water-soluble pouch is the binder, which may be a polymer blend. Selection of the binder may be guided by the desired strength and stability of the water-soluble pouch, as well as mucoadhesiveness, pliability, dissolution rate, and moisture content. The binder may also be referred to as a “film forming agent,” or more specifically a “film forming polymer” (or equivalent terms, such as “strip-forming polymer” and “mucoadhesive polymer”) when it is a polymer. Polymeric binders (film forming agents) can be natural or a synthetic. Employing a binder can allow for, and promote, the formation of a “film matrix” (also referred to as a polymeric matrix). A film matrix is typically obtained by curing the cast slurry, which contains the binder(s). Examples of binders for use in a WSP described herein include polyacrylic acid (PAA) (alternatively referred to as poly(acrylic acid) or Carbomer®); 1-polyacrylic acid; methyl methacrylate copolymer; carboxyvinyl polymer; polyethylene glycol (PEG) (alternatively referred to as polyethylene oxide or PEO); acacia; agar; alginic acid (alternatively referred to as algin); sodium alginate (Na alginate); calcium carbonate; calcium lactate; carboxymethyl cellulose (CMC) (alternatively referred to as cellulose gum or carboxy methylcellulose or carboxymethylcellulose); carrageenan; cellulose acetate; chitosan; copovidone; starch (e.g., corn starch or pregelatinized starch); cottonseed oil; dextrates; dextrin; dextrose (alternatively referred to as corn sugar and D-glucose); ethylcellulose; (alternatively referred to as ethyl cellulose); gelatin; guar gum; hydroxyethyl cellulose (HEC); hydroxyethyl methyl cellulose (MEMC); hydroxypropyl methylcellulose (HPMC) (alternatively referred to as hydroxypropyl methyl cellulose, hypromellose, or INN) (e.g., Vivapharm® HPMC E3, Methocel™ HPMC K3, Vivapharm® HPMC E5, Vivapharm® HPMC E15, or Methocel™ E15); hydroxypropyl cellulose (HPC); low substituted hydroxypropyl cellulose (L-HPC); hydroxypropyl starch; inulin; lactose; maltodextrin; maltose; methylcellulose (MC) (e.g., Methocel® A15); microcrystalline cellulose (MCC) (e.g., Avicel® PH-101); pectin; poloxamer (e.g., Pluronic®, Kolliphor®, and Synperonic®); polycarbophil; polydextrose; polymethacrylates; polyvinyl alcohol (PVA) (alternatively referred to as poly(vinyl alcohol), polyvinylalcohol or PVOH or PVAI); polyvinylpyrrolidone (PVP) (alternatively referred to as polyvidone or povidone) (e.g., Kollidon® K90, Kollidon® 12 PF, Kollidon® 17 PF, Kollidon® 25 PF, or Kollidon® 30 PF); pullulan; sodium carboxymethylcellulose (CMC-Na) (alternatively referred to as sodium carboxymethyl cellulose) (e.g., Cekol® 30); sucrose; sunflower oil; zein; vinylpyrrolidone-vinyl acetate copolymer (e.g., Kollidon® VA64); polyvinyl acetate/polyvinylpyrrolidone (e.g., Kollidon® SR); polyvinyl alcohol-polyethylene glycol copolymer and polyvinyl alcohol (PVA) (e.g., Kollicoat® Protect); polyvinyl alcohol/polyethylene glycol graft copolymer (e.g., Kollicoat® IR); polyvinyl caprolactampolyvinyl acetate-polyethylene glycol graft co-polymer (e.g., Soluplus®); poly(ethyl acrylate-co-methyl methacrylate-co-trimethylammonioethyl methacrylate chloride) (e.g., Eudragit® RL100); amino methacrylate copolymer (e.g., Eudragit® E PO); and xanthan gum.

The term “thickening agent” (and equivalent terms such as “thickener,” “gelling agent,” and “viscosity increasing agent”) refers to substances used in the pharmaceutical preparation of water-soluble pouches, to improve the viscosity and consistency of the slurry before casting. Active ingredient content uniformity is often a requirement for dosage forms, particularly those containing low dose highly potent active ingredients. To uniquely meet this requirement, water-soluble pouch formulations can contain uniform dispersions of active ingredient throughout the whole manufacturing process. Examples of thickening agents for use in a WSP described herein include acacia, agar, alginic acid, calcium alginate, carboxymethylcellulose calcium, carboxymethylcellulose sodium, carrageenan, ceratonia, chitosan, cyclomethicone, ethylcellulose, gelatin, glycerin, guar gum, hydrogenated vegetable oil, hydroxyethy cellulose, hydroxypropyl cellulose, hydroxypropyl starch, hypromellose, locust bean gum, maltodextrin, methylcellulose, pectin, polydextrose, polyethylene glycol, polyvinyl alcohol, potassium chloride, potassium alginate, povidone, propylene glycol alginate, sodium alginate, sodium chloride, starch, sucrose, sulfobutylether β-cyclodextrin, and xanthan gum.

The term “filler” (and equivalent terms such as “diluent” and “bulking agent”) refers to substances used in the pharmaceutical preparation of oral solid dosage forms (e.g., water-soluble pouch) to add bulk to the pharmaceutical dosage form, improving the consistency in dose metering and/or making the active ingredient easier for consumer to take. Fillers can also help with the manufacturing and stabilization of these products. Fillers can also bind and stabilize the dosage form. They are employed in the manufacture of a WSP to increase weight/mass and/or to improve content uniformity. Fillers can provide properties such as improved cohesion and/or to promote flow. Examples of fillers for use in a WSP described herein include anhydrous lactose, calcium carbonate, calcium lactate, calcium phosphate (dibasic anhydrous, dibasic dihydrate, or tribasic), calcium silicate, calcium sulfate, cellulose (powdered or silicified microcrystalline), cellulose acetate, corn starch and pregelatinized starch, dextrates, dextrin, dextrose, erythritol, ethylcellulose, fructose, fumaric acid, glucose, glyceryl palmitostearate, glycine, hydrolyzed starch, lactose, lactose monohydrate, isomalt, kaolin, lactitol, magnesium carbonate, magnesium oxide, maltodextrin, maltose, mannitol, medium-chain triglycerides, microcrystalline cellulose (MCC) (e.g., Endurance Microcrystalline Cellulose, FCC), partially pregelatinized starches, plant cellulose, polydextrose, polymethacrylates, simethicone, sodium alginate, sodium chloride, sorbitol, pregelatinized starch, sterilizable maize, sucrose, sugar spheres, sulfobutylether β-cyclodextrin, talc, tragacanth, trehalose, and xylitol.

The term “plasticizer” refers to a substance that, when added to polymer(s), makes the polymer more pliable and softer, enhancing the flexibility and plasticity of the films. They can be added to reduce the glass transition temperature to reduce the risk of thermally destabilizing the active ingredient and/or excipients. The plasticizer is believed to permeate the polymer structure, disrupting intermolecular hydrogen bonding, and permanently lowers intermolecular attractions. Plasticizers can be used to allow initial film forming, to reduce the brittleness, and improve the processability and flexibility of the resulting film, thereby avoiding cracking, e.g., during the curing process. Plasticizers can be used to improve elasticity of the water-soluble pouch which can be important for manufacturing scale-up. Plasticizers can also play a role when combined with certain polymers in the overall dissolution rate of the film. Examples of plasticizers for use in a WSP described herein include castor oil, glycerin, glycerol monostearate, D, hypromellose phthalate, mannitol, mineral oil and, palmitic acid, polyethylene glycol, polyvinyl acetate phthalate, propylene glycol, pyrrolidone, sorbitol, stearic acid, triacetin, tributyl citrate, triethyl citrate, water, glycerin fatty acid esters, sucrose fatty acid esters, lecithin, enzyme modified lecithin, polysorbates, sorbitan fatty acid esters, maltitol, xylitol, polyethylene glycol (PEG), hydrogenated starch syrup, starch syrup, and glycerol oleate.

The term “sequestering agent” refers to a compound that binds to and reduces the biological availability of a chemical or pharmaceutical agent. These substances, also known as chelating agents or chelators, form stable, water-soluble complexes with metal ions or other molecules, effectively “sequestering” them from their environment. Sequestering agents serve several important functions in pharmaceutical and nutraceutical applications. They can improve the stability of drug formulations by binding to metal ions that might otherwise catalyze degradation reactions. By binding to certain compounds, sequestering agents can alter their absorption, distribution, or elimination in the body. In some cases, they are used therapeutically to bind and remove toxic metals from the body. Additionally, sequestering agents can enhance the solubility or stability of certain drugs or nutrients in liquid formulations. Common examples of sequestering agents used in pharmaceutical contexts include ethylenediaminetetraacetic acid (EDTA), citric acid, nitrilotriacetic acid, sodium citrate, and dipicolinic acid.

The term “emulsifier” (and equivalent terms such as “emulsifying agent”) refers to a substance capable of forming or promoting an emulsion. In particular reference to the water-soluble pouches described herein, the emulsifier can promote the separation of phases (e.g., aqueous and lipids), while allowing them to be mixed. Examples of emulsifiers for use in a WSP described herein include acacia, cholesterol, glycerin, glyceryl monostearate, hydroxypropyl cellulose, lecithin (e.g., sunflower lecithin), methylcellulose, mineral oil and, monobasic sodium phosphate, monoethanolamine, oleic acid, polyethylene glycol, poloxamer, polyoxyethylene alkyl ethers, polyoxyethylene castor oil derivatives, polyoxyethylene sorbitan fatty acid esters, polyoxyethylene stearates, polysorbate (e.g., polysorbate 20, polysorbate 40, polysorbate 60, polysorbate 80, etc.), propylene glycol, propylene glycol alginate, sodium lauryl sulfate, sorbitan esters, and stearic acid.

The term “solubilizing agent” (and equivalent terms such as “solubilizer”) refers to a substance used in the pharmaceutical preparation of a water-soluble pouch, to increase the solubility and/or bioavailability of the active pharmaceutical ingredient (API) and/or excipients, to form a slurry. A solubilizing agent can act as a surfactant and increases the solubility of one agent in another. A substance that would not normally dissolve in a particular solution may be able to dissolve with the use of a solubilizing agent. Examples of solubilizing agents for use in an WSF described herein include cyclodextrins, glycerin monostearate, hydroxpropyl betadex, hypromellose, inulin, lecithin, meglumine, phospholipids, poloxamer, polyoxyethylene alkyl ethers, polyoxyethylene castor oil derivatives, polyoxyethylene sorbitan fatty acid esters, polyoxyethylene stearates, polyoxylglycerides, povidone, propylene glycol, pyrrolidone, sorbitan esters, starch, stearic acid, sulfobutylether β-cyclodextrin, tricaprylin, triolein, and vitamin E polyethylene glycol succinate, N-acetylated amino-acid derivative, ethoxylated sorbitan, mono and diglycerides. Upon curing of a slurry to provide a water-soluble pouch, a portion of the solubilizer may be removed.

The term “slurry” refers to a mixture of solids that is dispersed, suspended, solubilized, and/or dissolved in liquid. Together, the solids and liquid will include those substances used to manufacture the water-soluble pouch. The solid substances employed in the manufacture of the water-soluble pouch can essentially be dissolved in the liquid, can essentially be suspended in the liquid, can essentially be dispersed in the liquid, can essentially be solubilized in the liquid, or a combination thereof. A water-soluble pouch can be formed by curing a cast slurry. The curing can be carried out, e.g., at an elevated temperature, for a period of time. In doing so, a significant amount of the solvent (e.g., water) will be removed. The remaining water will contribute to the moisture content in the water-soluble pouch (in addition to any moisture from the surrounding environment that is picked up by any hygroscopic polymers employed).

The term “water soluble film” or “WSF” refers to is a type of plastic film designed to dissolve completely upon contact with water. Typically made from polyvinyl alcohol (PVA or PVOH), a synthetic polymer, WSF possesses unique properties that make it valuable for various applications. This biodegradable and non-toxic material not only dissolves in water without leaving harmful residues but also provides barrier properties against odors, aromas, bacteria, and gases. Water soluble film is heat-sealable and printable, enhancing its versatility in packaging applications. It finds widespread use in industries such as laundry and dishwashing (for detergent pods), agriculture, chemicals, flavors and colorants, textiles, and pharmaceuticals. The film's ability to dissolve completely in water makes it an eco-friendly alternative to traditional plastics, reducing plastic waste and packaging volume while not contributing to microplastic pollution. Additionally, WSF allows for pre-measured, unit-dose packaging of products, which enhances safety by reducing user contact with potentially hazardous substances and simplifies product use by eliminating the need for measuring. These combined attributes of convenience, safety, and environmental benefits have led to the increasing popularity of water-soluble pouch in various packaging and industrial applications.

The term “drug” refers to any chemical substance, other than a nutrient or an essential dietary ingredient, which, when administered to a living organism, produces a biological effect. In pharmacology, a drug is a chemical substance, typically of known structure, which, when administered to a living organism, produces a biological effect. A pharmaceutical drug, also called a medication or medicine, is a chemical substance used to treat, cure, prevent, or diagnose a disease or to promote well-being. Drugs can be obtained through extraction from medicinal plants or by organic synthesis. Pharmaceutical drugs may be used for a limited duration or on a regular basis for chronic disorders.

The term “nutraceutical” refers to a food or part of a food that provides medical or health benefits, including the prevention and treatment of disease. Nutraceuticals are nutritionally rich dietary substances made from whole food or parts of food sources, known to provide health benefits beyond their basic nutritional value. Examples include soy protein, garlic, green tea, and many others. Nutraceuticals are often marketed in forms not typically associated with food, such as pills, capsules, powders, or liquid formulations.

The term “dietary supplement” refers to a product intended to supplement the diet that bears or contains one or more dietary ingredients. These ingredients may include vitamins, minerals, herbs or other botanicals, amino acids, enzymes, tissues from organs or glands, metabolites, extracts, or concentrates. Dietary supplements come in various forms such as tablets, capsules, soft gels, gel caps, liquids, powders, and bars. They are intended to be taken orally and are labeled as dietary supplements.

The term “food ingredient” refers to any substance that is used in the manufacture or preparation of food and is present in the final product, even if in an altered form. This includes additives, processing aids, and substances used for technological purposes in food production. Food ingredients can be derived from natural sources or synthesized, and they serve various functions such as flavoring, coloring, preserving, or improving the nutritional value of food products.

The term “vitamin” refers to an organic compound and a vital nutrient that an organism requires in limited amounts. Vitamins are essential for normal growth, development, and bodily functions. They typically cannot be synthesized in sufficient quantities by the organism and must be obtained from the diet. Vitamins have diverse biochemical functions, including hormone-like regulation, antioxidant effects, and enzyme cofactors. They are classified as either water-soluble or fat-soluble, which affects how they are absorbed and stored in the body.

The term “dietary ingredient” refers to a component of a dietary supplement, as defined by the Dietary Supplement Health and Education Act (DSHEA) of 1994. Dietary ingredients include vitamins, minerals, herbs or other botanicals, amino acids, and substances such as enzymes, organ tissues, glandulars, and metabolites. They can also be extracts or concentrates of these substances. Dietary ingredients are intended to supplement the diet and are not considered conventional foods or sole items of a meal or diet.

The term “botanical” refers to a plant or plant part valued for its medicinal or therapeutic properties, flavor, and/or scent. Botanicals are often used in dietary supplements, traditional medicines, and natural health products. They can include herbs, roots, leaves, bark, flowers, fruits, or seeds. The term encompasses both fresh and processed plant materials, including whole plants, plant parts, and plant-derived substances such as essential oils or extracts.

The term “food product” refers to any substance, whether processed, semi-processed, or raw, that is intended for human consumption. This includes drinks, chewing gum, and any substance that has been used in the manufacture, preparation, or treatment of food. Food products can range from single-ingredient items to complex, multi-ingredient processed foods. They are regulated by food safety authorities to ensure they meet quality and safety standards for human consumption.

The term “functional food” refers to foods that have been demonstrated to provide specific health benefits beyond their basic nutritional value. These foods are usually enhanced or fortified with bioactive compounds, such as vitamins, minerals, probiotics, or fiber. Functional foods are intended to be consumed as part of a regular diet and are marketed with claims of potential health benefits. Examples include fortified milk products, probiotic yogurts, and omega-3 enriched eggs.

The term “medical food” refers to a food formulated to be consumed or administered enterally under the supervision of a physician. It is intended for the specific dietary management of a disease or condition for which distinctive nutritional requirements, based on recognized scientific principles, are established by medical evaluation. Medical foods are not drugs and do not require premarket approval by the FDA, but they must comply with all applicable food laws and regulations.

The term “probiotic” refers to live microorganisms that, when administered in adequate amounts, confer a health benefit on the host. Probiotics are typically bacteria or yeasts that are similar to beneficial microorganisms found in the human gut. They are often added to foods like yogurt or taken as dietary supplements. Probiotics are believed to help maintain a healthy balance of gut bacteria and have been studied for their potential effects on digestive health, immune function, and other aspects of health.

The term “microcrystalline” refers to a crystallized substance containing small crystals, wherein the crystalline lattice is visible only through microscopic examination.

“Microcrystalline cellulose” or “MCC” is a term used for refined wood pulp. A naturally occurring polymer, it is composed of glucose units connected by a 1-4 beta glycosidic bond. These linear cellulose chains are bundled together as microfibril spiraled together in the walls of plant cell. The term “silicified microcrystalline cellulose” refers to MCC which is silicified. Silicification is the process in which organic matter becomes saturated with silica. When present in the oral soluble film described herein, the microcrystalline cellulose can function as a filler. The microcrystalline cellulose can optionally further function as an anti-caking agent, emulsifier, bulking agent, viscosity increasing agent, binder, or any combination thereof.

The term “glycerin” refers to the substance having the IUPAC name propane-1,2,3-triol; CAS Number 56-81-5, 8043-29-6, 25618-55-7, 8013-25-0; chemical formula C₃H₈O₃ or CH₂OH—CHOH—CH₂OH; and molar mass 92.09 g/mol. The glycerin can be glycerin, 99% natural. The “99%” is a designation of purity and the “natural” is a designation that the substance is not synthetically prepared. When present in n water soluble film described herein, the glycerin can function as a plasticizer. The glycerin can optionally further function as a sweetener, humectant, solvent, thickening agent, lubricant, or any combination thereof.

The term “polyvinyl alcohol” or “PVA” refers to a water-soluble synthetic polymer. It has the chemical formula (C₂H₄O)ₓ, idealized formula [CH₂CH(OH)]ₙ, and CAS No. 9002-89-5.

The term “pullulan” refers to a natural polysaccharide polymer consisting of maltotriose units connected by α-1,6 glycosidic bonds. It has the chemical formula (C₆H₁₀O₅), and CAS No. 9057-02-7. When present in a water-soluble pouch described herein, pullulan can function as a film-forming agent. It can optionally further function as a binder, adhesive, and/or thickening agent.

The term “maltodextrin” refers to a polysaccharide that is used as a food additive. It consists of D-glucose units connected by α-1,4 and α-1,6 glycosidic bonds and has a dextrose equivalent (DE) of less than 20. It has the chemical formula (C₆H₁₀O₅) n and CAS No. 9050-36-6. When present in a water-soluble pouch described herein, maltodextrin can function as a bulking agent. It can optionally further function as a thickener, stabilizer, and/or binding agent.

The term “sodium alginate” refers to the sodium salt of alginic acid, a polysaccharide distributed widely in the cell walls of brown algae. It has the chemical formula (C₆H₇NaO₆) n and CAS No. 9005-38-3. When present in a water-soluble pouch described herein, sodium alginate can function as a thickening agent. It can optionally further function as a stabilizer, emulsifier, and/or gelling agent.

The term “sorbitol” refers to a sugar alcohol with a sweet taste which the human body metabolizes slowly. It has the chemical formula C₆H₁₄O₆, CAS No. 50-70-4, and IUPAC name (2S,3R,4R,5R)-hexane-1,2,3,4,5,6-hexol. When present in a water-soluble pouch described herein, sorbitol can function as a sweetener. It can optionally further function as a humectant, texturizer, and/or stabilizer.

The term “sodium citrate” refers to the sodium salt of citric acid with the chemical formula Na₃C₆H₅O₇. It has CAS No. 68-04-2. When present in a water-soluble pouch described herein, sodium citrate can function as a pH adjusting agent. It can optionally further function as a preservative, emulsifier, and/or flavor enhancer.

The term “sunflower lecithin” refers to a mixture of phospholipids derived from sunflower seeds. It has CAS No. 8002-43-5. When present in a water-soluble pouch described herein, sunflower lecithin can function as an emulsifier. It can optionally further function as a stabilizer and/or dispersing agent.

The term “sodium carboxymethyl cellulose” refers to a cellulose derivative with carboxymethyl groups bound to hydroxyl groups of the glucopyranose monomers. It has the chemical formula [C₆H₇O₂(OH)₂CH₂COONa], and CAS No. 9004-32-4. When present in a water-soluble pouch described herein, sodium carboxymethyl cellulose can function as a thickening agent. It can optionally further function as a stabilizer, binder, and/or film-forming agent.

The term “propylene glycol” refers to an organic compound with the chemical formula C₃H₈O₂ or CH₃CH(OH)CH₂OH. It has CAS No. 57-55-6. When present in a water-soluble pouch described herein, propylene glycol can function as a humectant. It can optionally further function as a solvent, preservative, and/or stabilizer.

The term “polysorbate 80” refers to a nonionic surfactant and emulsifier derived from polyethoxylated sorbitan and oleic acid. It has the chemical formula C₆₄H₁₂₄O₂₆ and CAS No. 9005-65-6. When present in a water-soluble pouch described herein, polysorbate 80 can function as an emulsifier. It can optionally further function as a dispersing agent and/or stabilizer.

The term “xylitol” refers to a sugar alcohol used as a sweetener. It has the chemical formula C₅H₁₂O₅, CAS No. 87-99-0, and IUPAC name (2R,3R,4S)-pentane-1,2,3,4,5-pentol. When present in a water-soluble pouch described herein, xylitol can function as a sweetener. It can optionally further function as a humectant and/or texturizer.

### Embodiments

In specific embodiments, the water-soluble pouch of the present invention possesses any one or more of the following characteristics:

### Dissolution Rate

Fast dissolution: Complete dissolution in less than 25 seconds at room temperature (20° C.)
Full dissolution: 100% dissolution within 5 minutes
Temperature range:
   Cold water solubility: Below 20° C.
   Hot water solubility: 60-80° C.

### Mechanical Properties.

Tensile strength: At least 11-12 N/mm² (as measured by Modulus of Elasticity)
Stretch degree: 40% to 500%, preferably 40% to 200%
Puncture resistance: Specific values not provided, but should be high enough to withstand normal handling

### Barrier Properties

Oxygen transmission rate: As low as possible, specific values depend on application
Water vapor transmission rate: As low as possible to prevent premature dissolution

### Size and Capacity

Edge lengths: Less than 100 mm, often less than 60 mm or 50 mm
Plan area: Less than 10,000 mm², often less than 2,500 mm²

### Environmental Impact

Biodegradability: 100% biodegradable
Marine biodegradation: Meet EPA's Ecological Risk Assessment standards

### Performance Metrics

Shelf life: Typically 12-24 months, depending on the product and storage conditions
Viscosity of contained liquid: 50 to 10,000 cps, preferably 300 to 6,000 cps (for liquid detergents)

### Composition

Total water content: Less than 25%, preferably less than 10%, optimally 1% to 8% by weight
Film thickness: Typically 20-100 microns, depending on the application

### Market Considerations

Cost-effectiveness: Competitive with traditional packaging while offering added benefits
Regulatory compliance: Meet FDA standards for food contact materials, where applicable

These characteristics provide a framework for water-soluble pouches that balance functionality, convenience, and/or environmental sustainability.

### EXAMPLES

### Example 1a. Water Soluble Pouch, Formulation

| | | | | | | Non- |
|---|---|---|---|---|---|---|
| | | | | | | volatile |
| | | Slurry | Slurry | | WSP | (wt. %) |
| | Ingredient | Amount | Range | Mass/POD | Amount | (dehydrated |
| Ingredient | Function | (wt. %) | (wt. %) | (mg) | (wt. %) | film) |
| Water, Purified | Solvent | 46.600 | 35-55 | 125 | 5.00 | 0.00 |
| USP | | | | | | |
| Pullulan | Binder | 2.210 | 1.5-3 | 98.29 | 3.93 | 4.14 |
| Maltodextrin | Thickener | 20.740 | 18-23 | 922.43 | 36.90 | 38.84 |
| Endurance | Filler | 8.080 | 6-10 | 359.36 | 14.37 | 15.13 |
| Microcrystalline | | | | | | |
| Cellulose, FCC | | | | | | |
| Na alginate | Binder | 0.840 | 0.5-2 | 37.36 | 1.49 | 1.57 |
| Sorbitol | Plasticizer | 2.78 | 1.5-3.5 | 123.64 | 4.95 | 5.21 |
| Sodium Citrate | Sequestering | 5.25 | 3-6.5 | 233.50 | 9.34 | 9.83 |
| | agent | | | | | |
| Glycerin 99.7% | Plasticizer | 13.50 | 12-15 | 600.42 | 24.02 | 25.28 |
| USP | | | | | | |
| | Total: | 100.000 | | 2500.00 | 100 | 100.00 |

### Example 1b. Water Soluble Pouch, Formulation

| | | | | | | Non-volatile |
|---|---|---|---|---|---|---|
| | | | Slurry | | | wt. % |
| | Ingredient | Slurry | wt. % | Mass/POD | WSP | (dehydrated |
| Ingredient | Function | wt. % | Range | (mg) | wt. % | film) |
| Water, Purified | Solvent | 49.640% | 35-55% | 125 | 5.00% | 0.00% |
| USP | | | | | | |
| Pullulan | Binder | 4.910% | 3-6% | 231.56 | 9.26% | 9.75% |
| Maltodextrin | Thickener | 12.800% | 10-15% | 603.65 | 24.15% | 25.42% |
| Endurance | Filler | 5.060% | 3.0-8.0% | 238.63 | 9.55% | 10.05% |
| Microcrystalline | | | | | | |
| Cellulose, FCC | | | | | | |
| Na alginate | Binder | 1.360% | 0.5-2.5% | 64.14 | 2.57% | 2.70% |
| Sorbitol | Plasticizer | 2.78% | 1.5-4.0% | 131.11 | 5.24% | 5.52% |
| Sodium Citrate | Sequestering | 5.25% | 3-6.5% | 247.59 | 9.90% | 10.42% |
| | agent | | | | | |
| Glycerin 99.7% | Plasticizer | 15.20% | 12-17% | 716.84 | 28.67% | 30.18% |
| USP | | | | | | |
| Sunflower | Emulsifier | 3.00% | 2.0-4.5% | 141.48 | 5.66% | 5.96% |
| Lecithin | | | | | | |
| | Total: | 100.000% | | 2500.00 | 100% | 100.00% |

### Example 1c. Water Soluble Pouch, Formulation

| | | | | | | Non-volatile |
|---|---|---|---|---|---|---|
| | | | Slurry | | | wt. % |
| | Ingredient | Slurry | wt. % | Mass/POD | WSP | (dehydrated |
| Ingredient | Function | wt. % | Range | (mg) | wt. % | film) |
| Water, Purified | Solvent | 86.470% | 80-90% | 125 | 5.00% | 0.00% |
| USP | | | | | | |
| Polyvinyl | Binder | 8.570% | 6-12% | 1504.34 | 60.17% | 63.34% |
| Alcohol | | | | | | |
| Sodium | Binder | 1.120% | 0.5-3.0% | 196.60 | 7.86% | 8.28% |
| Carboxymethyl | | | | | | |
| Cellulose | | | | | | |
| Propylene | Solubilizer/ | 1.690% | 1.0-3.0% | 296.66 | 11.87% | 12.49% |
| Glycol | emulsifier | | | | | |
| Polysorbate 80 | Emulsifier | 0.120% | 0.1-2.0% | 21.06 | 0.84% | 0.89% |
| Xylitol | Plasticizer | 0.750% | 0.5-2.0% | 131.65 | 5.27% | 5.54% |
| Sorbitol | Plasticizer | 0.63% | 0.5-2.0% | 110.59 | 4.42% | 4.66% |
| Glycerin 99.7% | Plasticizer | 0.65% | 0.5-2.0% | 114.10 | 4.56% | 4.80% |
| USP | | | | | | |
| | Total: | 100.000% | | 2500.00 | 100% | 100.00% |

### Example 2a. Water Soluble Pouch, Method of Manufacturing

A water-soluble pouch can be manufactured from the formulation of Example 1a, as shown below.
1. Heat the allotted amount of water to 90° C. in glass beaker using a hot plate. Place a 500 ml glass beaker on a Radwag benchtop scale and weigh out the allotted amount of water. Place the beaker on a Corning PC-420D hot plate and set the hot plate to 90° C.
2. Stir water with bench top overhead mixer at 200-400 rpm. Using an IKA RW 20 digital mixer, stir the water between 200-400 rpm while the beaker is on the Corning PC-420D hot plate. Continue stirring until the water is 90° C.
3. Add glycerin to a beaker. Using a Radwag benchtop scale, weigh out the allotted amount of glycerin and sunflower lecithin. Pour the glycerin and sunflower lecithin into the glass beaker to mix it with the heated water. Mix until the solution is homogenous.
4. Mix sorbitol, sodium citrate, and microcrystalline cellulose in a separate container. Place a separate beaker onto a Radwag benchtop scale. Weigh out the allotted amount of sorbitol, sodium citrate, and microcrystalline cellulose. Using a spatula, mix the powders until the powder mix is homogenous. Add the homogenous powder mix to the water/glycerin solution while mixing.
5. Adjust the speed of the mixer if needed. The mixing speed may increase up to 800-1000 rpm depending on the batch size. Continue mixing until the solution is homogenous. This may take up to 10-20 minutes.
6. Mix pullulan, maltodextrin, and sodium alginate in a separate container. Place a separate beaker onto a Radwag benchtop scale. Weigh out the allotted amount of pullulan, maltodextrin, and sodium alginate. Using a spatula, mix the powders until the powder mix is homogenous. Slowly add the homogenous powder mix to the heated solution while mixing.
7. Adjust the speed of the mixer if needed. The mixing speed may increase up to 1400-1600 rpm depending on the batch size. Continue mixing until the solution is homogenous. This may take up to 2-3 hours.
8. Extrude slurry onto siliconized paper using a pin gauge between 200-350 mcm. Remove the beaker from the hot plate and allow to cool for 10 minutes. Adjust the Gardco extruder to a pin gauge between 200-350 mcm. Pour the slurry onto the top of the siliconized paper and use the Gardco extruder to extrude the slurry on the siliconized paper by dragging the extruder to the bottom of the siliconized paper.
9. Cure slurry in convection oven at 85-110° C. Set the temperature of a Vulcan convection oven to between 85-110° C. When the oven reaches the desired temperature, place the siliconized paper with extruded slurry into the convection oven. Allow the slurry to dry until it becomes an anhydrous film. This may take between 6-15 minutes. When the film is dry, remove the product from the oven.
10. Using benchtop POD sealer, create a POD with powder enclosed. Turn on benchtop POD sealer and allow to heat to the default temperature of 120° C. Remove one section of film from the siliconized paper. Remove the metal plate of the benchtop POD sealer and place the film on top of the well. Reattach the metal plate with the film product over the well. Activate the POD sealer to vacuum the film. Place the desired active powder into the well while the film is vacuumed. Take another section of film and remove it from the siliconized paper. Run the film across a damp rag to obtain moisture. Place the film on top of the well and the desired active powder and seal the pouch by activating the POD sealer. Remove the product from the POD sealer (Polyva Lab Scale Pods Sample Making Machine Liquid Laundry Pods Testing Machine PVA film Making Machine Water Test Pump, commercially available from POLYVA located in Guangdong, China). Cut off excess film product using scissors.

### Example 2b. Water Soluble Pouch, Method of Manufacturing

A water-soluble pouch can be manufactured from the formulation of Example 1b, as shown below.
1. Heat allotted amount of water to 85° C. in glass beaker using a hot plate.
2. Stir water with bench top overhead mixer at 200-400 rpm.
3. Add glycerin and lecithin to a beaker.
4. Mix sorbitol, sodium citrate and microcrystalline cellulose in a separate container. Add the homogenous powder mix to the beaker while mixing.
5. Adjust the speed of the mixer if needed.
6. Mix pullulan, maltodextrin, and sodium alginate in a separate container. Slowly add the homogenous powder mix to the beaker while mixing.
7. Adjust the speed of the mixer if needed.
8. Extrude slurry onto siliconized paper using a pin gauge between 200-350 mcm.
9. Cure slurry in convection oven at 85-110° C.
10. Using benchtop POD sealer, create a POD with powder enclosed.

### Example 2c. Water Soluble Pouch, Method of Manufacturing

A water-soluble pouch can be manufactured from the formulation of Example 1c, as shown below.
1. Disperse PVA into allotted room temperature water in a glass beaker and stir with overhead mixer at 200-400 rpm.
2. Heat solution to 90° C. on a hot plate while mixing with overhead mixer.
3. Increase stirring rpm if needed. Continue mixing until PVA is dissolved.
4. While mixing, add glycerin, propylene glycol and polysorbate 80 to the solution.
5. Mix sorbitol, xylitol, and carboxymethyl cellulose in a separate container. Add the homogenous powder mix to the beaker while mixing.
6. Adjust the speed of the mixer if needed.
7. Continue mixing until all solids are dissolved into the solution. Remove mixer and hot plate.
8. Allow solution to sit until all bubbles are removed and the slurry is transparent (Can take up to several hours).
9. Extrude slurry onto siliconized paper using a pin gauge between 500-800 mcm.
10. Cure slurry in convection oven at 85-110° C.
11. Using benchtop POD sealer, create a POD with powder enclosed.

### Example 3: Physical Parameters, Water-Soluble Pouch

The water-soluble pouch can be measured to determine values for the below parameters.

### Product Performance Parameters

| | Acceptable | | |
|---|---|---|---|
| Parameter | Range | | Remarks |
| Tensile | 30-100 | MPa | PVOH films exhibit high strength (30-100 MPa). |
| Strength | | | Blends with proteins/nanofillers may achieve |
| | | | 6-10 MPa. |
| Elongation | 100-600% | | PVOH films show high flexibility. Composite |
| | | | films (e.g., soy/PVA) range 20-60%. |
| Disintegration | <30 | seconds | SmartSolve's 5E07 dissolves in 5-10 sec. |
| Time | | | Fast-disintegrating films achieve <60 sec. |

| | | |
|---|---|---|
| Flavor | Flavorless | PVOH and HPMC-based films are neutral, avoiding |
| | | taste interference. |

### Manufacturing Parameters

| | Acceptable | | |
|---|---|---|---|
| Parameter | Range | | Role in Vacuum Forming |
| Tensile | ≥30 | MPa | Ensures film withstands vacuum pressure |
| Strength | | | without tearing during molding. |
| Elongation | ≥100% | | Critical for deep draws (e.g., plug- |
| | | | assisted forming) to prevent cracking. |
| Folding | >300 | folds | Indicates flexibility; essential for |
| Endurance | | | handling during thermoforming. |
| Thickness | 50-150 | μm | Thinner films (e.g., 50-100 μm) dissolve |
| | | | faster; thicker films (100-150 μm) |
| | | | enhance durability. |

### Key Considerations for Vacuum Forming

1. Thermoforming Compatibility:
   PVOH and HPMC films are thermoplastic when plasticized, enabling vacuum-press/plug-assist molding.
   Uniform thickness (50-150 μm) ensures consistent heat distribution and material flow.
2. Plug-Assist Requirements:
   High elongation (>100%) and folding endurance (>300) prevent film rupture during deep draws.
   Films with 30-100 MPa tensile strength maintain structural integrity under mechanical stress.
3. Process Optimization:
   Lower thickness (e.g., 50-75 μm) reduces energy use but requires precise temperature control to avoid defects.
   Additives like nano-TiO₂ or glycerol enhance thermoformability without compromising dissolution.

### Example Formulations

| | Tensile | | | Disintegration | |
|---|---|---|---|---|---|
| Material | Strength | | Elongation | Time | |
| PVOH | 30-100 | MPa | 100-600% | 5-10 | sec |
| Soy Protein/ | 6.77 | MPa | 58.91% | N/A | |
| PVA + TiO₂ | | | | | |
| HPMC-CLCMRS | 0.66-1.75 | MPa | 7.27-11.07% | 70-214 | sec |
| Composite | | | | | |

For nutraceutical applications, PVOH-based films are sometimes preferred for their balance of strength, flexibility, and rapid dissolution. It is highly recommended to always validate compatibility with active ingredients and storage conditions (humidity/temperature).

What is claimed:

1. A water-soluble pouch comprising:

| | Ingredient | Non-volatile (wt. %) | WSP |
|---|---|---|---|
| Ingredient | Function | (dehydrated film) | (wt. %) |
| Water, Purified USP | Solvent | up to 0.1 | 5.00 ± 1 |
| Pullulan | Binder | 4.14 ± 1 | 3.93 ± 1 |
| Maltodextrin | Thickener | 38.84 ± 5 | 36.90 ± 7 |
| Endurance | Filler | 15.13 ± 3 | 14.37 ± 3 |
| Microcrystalline | | | |
| Cellulose, FCC | | | |
| Na alginate | Binder | 1.57 ± 0.3 | 1.49 ± 0.3 |
| Sorbitol | Plasticizer | 5.21 ± 1 | 4.95 ± 1 |
| Sodium Citrate | Sequestering | 9.83 ± 1 | 9.34 ± 2 |
| | agent | | |
| Glycerin 99.7% USP | Plasticizer | 25.28 ± 5 | 24.02 ± 5 |
| | Total: | 100.00 | 100 |

2. A water-soluble pouch comprising:

| | Ingredient | Non-volatile (wt. %) | WSP |
|---|---|---|---|
| Ingredient | Function | (dehydrated film) | (wt. %) |
| Water, Purified USP | Solvent | 0.00 | 5.00 |
| Pullulan | Binder | 4.14 | 3.93 |
| Maltodextrin | Thickener | 38.84 | 36.90 |
| Endurance | Filler | 15.13 | 14.37 |
| Microcrystalline | | | |
| Cellulose, FCC | | | |
| Na alginate | Binder | 1.57 | 1.49 |
| Sorbitol | Plasticizer | 5.21 | 4.95 |
| Sodium Citrate | Sequestering | 9.83 | 9.34 |
| | agent | | |
| Glycerin 99.7% USP | Plasticizer | 25.28 | 24.02 |
| | Total: | 100.00 | 100 |

3. A water-soluble pouch comprising:

| | Ingredient | WSP | Non-volatile wt. % |
|---|---|---|---|
| Ingredient | Function | wt. % | (dehydrated film) |
| Water, Purified USP | Solvent | 5.00 ± 2 | up to 0.1 |
| Pullulan | Binder | 9.26 ± 2 | 9.75 ± 2 |
| Maltodextrin | Thickener | 24.15 ± 5 | 25.42 ± 5 |
| Endurance | Filler | 9.55 ± 2 | 10.05 ± 2 |
| Microcrystalline | | | |
| Cellulose, FCC | | | |
| Na alginate | Binder | 2.57 ± 0.6 | 2.70 ± 0.6 |
| Sorbitol | Plasticizer | 5.24 ± 1 | 5.52 ± 1.1 |
| Sodium Citrate | Sequestering | 9.90 ± 2 | 10.42 ± 2 |
| | agent | | |
| Glycerin 99.7% USP | Plasticizer | 28.67 ± 6 | 30.18 ± 6 |
| Sunflower Lecithin | Emulsifier | 5.66 ± 1.1 | 5.96 ± 1.1 |
| | Total: | 100% | 100.00% |

4. A water-soluble pouch comprising:

| | Ingredient | WSP | Non-volatile wt. % |
|---|---|---|---|
| Ingredient | Function | wt. % | (dehydrated film) |
| Water, Purified USP | Solvent | 5.00 | 0.00 |
| Pullulan | Binder | 9.26 | 9.75 |
| Maltodextrin | Thickener | 24.15 | 25.42 |
| Endurance | Filler | 9.55 | 10.05 |
| Microcrystalline | | | |
| Cellulose, FCC | | | |
| Na alginate | Binder | 2.57 | 2.70 |
| Sorbitol | Plasticizer | 5.24 | 5.52 |
| Sodium Citrate | Sequestering | 9.90 | 10.42 |
| | agent | | |
| Glycerin 99.7% USP | Plasticizer | 28.67 | 30.18 |
| Sunflower Lecithin | Emulsifier | 5.66 | 5.96 |
| | Total: | 100% | 100.00% |

5. A water-soluble pouch comprising:

| | Ingredient | WSP | Non-volatile wt. % |
|---|---|---|---|
| Ingredient | Function | wt. % | (dehydrated film) |
| Water, Purified USP | Solvent | 5.00 ± 1 | up to 0.01 |
| Polyvinyl Alcohol | Binder | 60.17 ± 12 | 63.34 ± 15 |
| Sodium | Binder | 7.86 ± 1.5 | 8.28 ± 2 |
| Carboxymethyl | | | |
| Cellulose | | | |
| Propylene Glycol | Solubilizer/ | 11.87 ± 2.2 | 12.49 ± 2.5 |
| | emulsifier | | |
| Polysorbate 80 | Emulsifier | 0.84 ± 0.2 | 0.89 ± 0.2 |
| Xylitol | Plasticizer | 5.27 ± 1.2 | 5.54 ± 1.1 |
| Sorbitol | Plasticizer | 4.42 ± 1 | 4.66 ± 1 |
| Glycerin 99.7% USP | Plasticizer | 4.56 ± 1 | 4.80 ± 1 |
| | Total: | 100% | 100.00% |

6. A water-soluble pouch comprising:

| | Ingredient | WSP | Non-volatile wt. % |
|---|---|---|---|
| Ingredient | Function | wt. % | (dehydrated film) |
| Water, Purified USP | Solvent | 5.00 | 0.00 |
| Polyvinyl Alcohol | Binder | 60.17 | 63.34 |
| Sodium | Binder | 7.86 | 8.28 |
| Carboxymethyl | | | |
| Cellulose | | | |
| Propylene Glycol | Solubilizer/ | 11.87 | 12.49 |
| | emulsifier | | |
| Polysorbate 80 | Emulsifier | 0.84 | 0.89 |
| Xylitol | Plasticizer | 5.27 | 5.54 |
| Sorbitol | Plasticizer | 4.42 | 4.66 |
| Glycerin 99.7% USP | Plasticizer | 4.56 | 4.80 |
| | Total: | 100% | 100.00% |

7. The water-soluble pouch of any one of claims 1-6, further comprising inside the pouch: (i) drug, (ii) nutraceutical, (iii) dietary supplement, (iv) food ingredient, (v) vitamin, (vi) dietary ingredient, (vii) botanical, (viii) food product, (ix) functional food, (xi) medical food, and/or (xii) probiotic.

8. The water-soluble pouch of any one of claims 1-6, having a mass of 2.5±0.5 grams.

9. A method comprising orally administering the water-soluble pouch of claim 7, to an animal.
